(19) United States
(12) Patent Application Publication
(10) Pub. No.: US 2022/0126281 A1
(43) Pub. Date: Apr. 28, 2022

(54) PROCESS FOR REGENERATING A DEHYDROGENATION CATALYST

(71) Applicant: UOP LLC, Des Plaines, IL (US)

(72) Inventors: Avram M. Buchbinder, Chicago, IL (US); John J. Senetar, Naperville, IL (US); Richard A. Johnson, II, Algonquin, IL (US); Sathit Kulprathipanja, Schaumburg, IL (US); Wei Pan, Hoffman Estates, IL (US)

(21) Appl. No.: 17/570,178

(22) Filed: Jan. 6, 2022

Related U.S. Application Data
(60) Provisional application No. 63/217,088, filed on Jun. 30, 2021.

(51) Int. Cl. B01J 38/02; B01J 23/62; B01J 35/10

(52) U.S. Cl. CPC B01J 38/02; B01J 35/1019; B01J 23/62

(57) ABSTRACT

A process for regenerating spent catalyst by combusting coke and fuel gas together in the presence of enriched oxygen restores activity to the catalyst to bring back to adequate activity level while reducing or obviating the need for the oxygen treatment step. The oxygen concentration in the oxygen supply gas should be greater than 21 vol %.

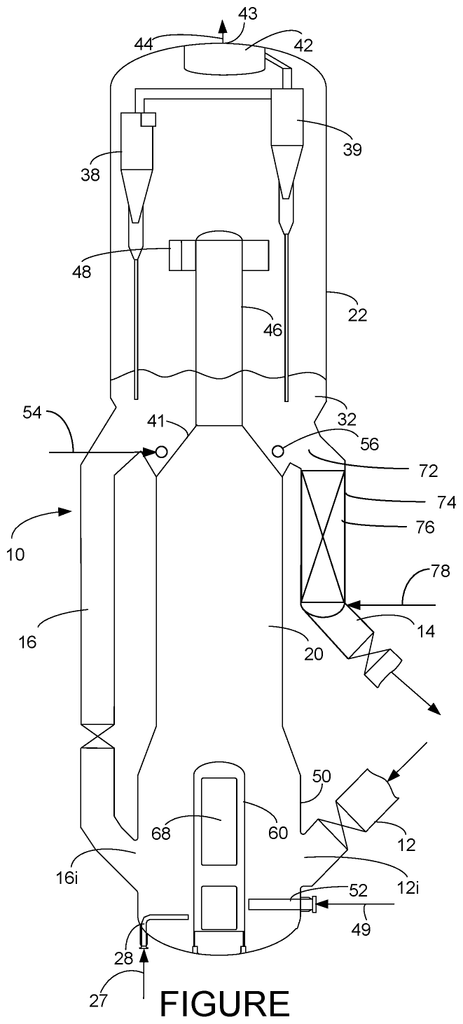

### CROSS-REFERENCE TO RELATED APPLICATIONS

This application claims priority from U.S. Provisional Application No. 63/217,088, filed Jun. 30, 2021, which is incorporated herein in its entirety.

### FIELD

The field is the regeneration and heating a coked, fluidized catalyst.

### BACKGROUND

Light olefin production is vital to the production of sufficient plastics to meet worldwide demand. Paraffin dehydrogenation (PDH) is a process in which light paraffins such as propane and butane can be dehydrogenated to make propylene and butylene, respectively. Dehydrogenation is an endothermic reaction which requires external heat to drive the reaction to completion.

In PDH reactions with fluidized catalyst, coke can deposit on the catalyst while catalyzing the reaction. The catalyst may be regenerated in a catalyst regenerator by combusting coke from the catalyst in the presence of oxygen. The hot regenerated catalyst may then be transferred back to the reactor to catalyze the reaction. However, the coke produced in the PDH reaction can provide insufficient heat from combustion in the regenerator to promote the endothermic dehydrogenation process. Hence, supplemental fuel such as fuel gas may be fed to the catalyst regenerator to heat the catalyst sufficiently to transfer sufficient enthalpy to drive the endothermic reaction. Conversely, if insufficient heat is provided to drive the endothermic reaction, olefin production can suffer.

Dehydrogenation catalyst may incorporate a dehydrogenation metal and a catalyst support such as alumina. The dehydrogenation metal comprises a noble metal present with gallium which is a highly active and selective catalyst metal function for dehydrogenation. The catalyst deactivates quickly within a cycle, so it is regenerated frequently. The frequent cycling between reaction and regeneration results in deactivation of the catalyst over time which must be restored. One way to regenerate the catalyst is carried out by first subjecting the catalyst to a combustion step with a low concentration of oxygen and subsequently reactivating the catalyst with a treatment in air or oxygen containing gas for longer than two minutes. This long regeneration process adds expense to the process by necessitating larger vessels and air handling systems.

Thus, there is a need for improved regeneration processes for noble metal and gallium catalysts.

### BRIEF SUMMARY

We have found that regenerating the catalyst by combusting coke and fuel gas together in the presence of enriched oxygen restores activity to the catalyst to bring back to adequate activity level while reducing or obviating the need for the oxygen treatment step.

### BRIEF DESCRIPTION OF THE DRAWINGS

The FIGURE is a schematic elevational drawing of a process of the present disclosure.

### Definitions

The term “communication” means that fluid flow is operatively permitted between enumerated components, which may be characterized as “fluid communication”.

The term “downstream communication” means that at least a portion of fluid flowing to the subject in downstream communication may operatively flow from the object with which it fluidly communicates.

The term “fuel gas” comprises hydrocarbons, hydrogen and mixtures thereof.

The term “oxygen supply gas” comprises a gas comprising oxygen, such as air.

As used herein, the term “predominant” or “predominate” means greater than 50%, suitably greater than 75% and preferably greater than 90%.

### DETAILED DESCRIPTION

The disclosure provides a process for regenerating catalyst that obviates a lengthy post-regeneration air treatment process that was previously thought required for gallium catalyst. The catalyst is regenerated by contact with fuel gas and oxygen supply gas that is enriched in oxygen which sufficiently heats the catalyst by combusting coke on the catalyst and combusting the fuel gas. The regeneration restores catalytic activity to what it had before in the cycle of exposure to the paraffinic reactants in a dehydrogenation reactor. Activity is restored even on catalysts that deactivated despite accumulating negligible amounts of coke. The regeneration occurs despite the presence of large amounts of steam and carbon dioxide which are generated as combustion products.

The teachings herein may be applicable to any process that requires a gallium catalyst to be reheated and/or regenerated for an endothermic reaction. Paraffin dehydrogenation is an example of such a process. Dehydrogenation catalyst is used in a dehydrogenation reaction process to catalyze the dehydrogenation of ethane and/or propane to ethylene and propylene.

The conditions in the dehydrogenation reaction may include a temperature of about 500 to about 800° C., a pressure of about 40 to about 310 kPa and a catalyst-to-oil ratio of about 5 to about 100. The dehydrogenation reaction may be conducted in a fluidized manner such that gas, which may be the reactant paraffins or a fluidizing inert gas, is distributed to the reactor in a way that lifts the dehydrogenation catalyst in the reactor vessel while catalyzing the dehydrogenation of propane and/or butane. During the catalytic dehydrogenation reaction, coke is deposited on the dehydrogenation catalyst to reduce the activity of the catalyst. Other transformations such as reduction of the active sites may also deactivate some catalysts. The dehydrogenation catalyst must then be regenerated.

It has been reported that a separate air treatment is required after coke has been combusted from the catalyst and the catalyst heated sufficiently to transport sufficient enthalpy for the heat of reaction in the reactor. We have found that by increasing oxygen concentration sufficiently in an oxygen supply gas provided for combustion of fuel gas in the presence of the catalyst and combustion of coke on the catalyst, the need for the air treatment step may be reduced or eliminated altogether, and that the regeneration occurs with increased oxygen concentration despite the presence of steam and/or carbon dioxide generated from combustion of fuel and coke.

The dehydrogenation catalyst selected should minimize cracking reactions and favor dehydrogenation reactions. Suitable catalysts for use herein include an active metal which may be dispersed in a porous inorganic carrier material such as silica, alumina, silica alumina, zirconia, or clay. An exemplary embodiment of a catalyst includes alumina or silica-alumina containing gallium, a noble metal, and an alkali or alkaline earth metal.

The catalyst support comprises a carrier material, a binder and an optional filler material to provide physical strength and integrity. The carrier material may include alumina or silica-alumina. Silica sol or alumina sol may be used as the binder. The alumina or silica-alumina generally contains alumina of gamma, theta and/or delta phases. The catalyst support particles may have a nominal diameter of about 20 to about 200 micrometers with the average diameter of about 50 to about 150 micrometers. Preferably, the surface area of the catalyst support is 85-140 m²/g.

The dehydrogenation catalyst may support a dehydrogenation metal. The dehydrogenation metal may be a one or a combination of transition metals. A noble metal may be a preferred dehydrogenation metal such as platinum or palladium. Gallium is an effective supporting metal for paraffin dehydrogenation. Metals may be deposited on the catalyst support by impregnation or other suitable methods or included in the carrier material or binder during catalyst preparation.

The acid function of the catalyst should be minimized to prevent cracking and favor dehydrogenation. Alkali metals and alkaline earth metals may also be included in the catalyst to attenuate the acidity of the catalyst. Rare earth metals may be included in the catalyst to control the activity of the catalyst. Concentrations of 0.001% to 10 wt % metals may be incorporated into the catalyst. In the case of the noble metals, it is preferred to use about 10 parts per million (ppm) by weight to about 600 ppm by weight noble metal. More preferably it is preferred to use 10-100 ppm by weight noble metal. The preferred noble metal is platinum. Gallium should be present in the range of 0.3 wt % to about 3 wt %, preferably about 0.5 wt % to about 2 wt %. Alkali and alkaline earth metals are present in the range of about 0.05 wt % to about 1 wt %.

The spent catalyst is transported to the catalyst regenerator vessel 10 to regenerate the spent catalyst into regenerated catalyst and to combust the coke if present. The catalyst regenerator vessel 10 includes a combustion chamber 20, which may be a lower chamber, and a separation chamber 22, which may be an upper chamber. The combustion chamber may include a mixing chamber 50 which mixes streams of catalyst and distributes gases to the catalyst. In the separation chamber 22, the regenerated catalyst is separated from flue gas generated in the combustion chamber 20. An oxygen supply gas distributor 52 provides oxygen supply gas from an oxygen supply gas line 49 to the combustion chamber 20. A plurality of oxygen supply gas distributors 52 may be employed to provide oxygen supply gas from the oxygen supply gas line 49 to the combustion chamber 20. A fuel gas distributor 28 distributes fuel gas from a fuel gas line 27 to the combustion chamber 20. Both gas streams lift the catalyst in the combustion chamber 20 into the separation chamber 22. A plurality of fuel gas distributors 28 may be employed to provide fuel gas from the fuel gas line 27 to the combustion chamber 20.

In an exemplary embodiment, the regenerator vessel 10 includes a mixing chamber 50. The mixing chamber may be located at a lower end of the of the combustion chamber 20 and the regenerator vessel 10. The mixing chamber 50 may include a spent catalyst pipe inlet 12i from the spent catalyst standpipe 12 which serves as an outlet for the spent catalyst standpipe. A spent catalyst standpipe 12 transports spent catalyst from the dehydrogenation reactor (not shown) to the catalyst regenerator vessel 10 through a control valve. The mixing chamber 50 may also include a regenerated catalyst pipe inlet 16i from a regenerated catalyst standpipe 16 which serves as an outlet for the regenerated catalyst standpipe. Heated regenerated catalyst from the separation chamber 22 may be transported back to the catalyst regenerator vessel 10 through a recycle regenerated catalyst standpipe 16 through a control valve to further heat catalyst in the regenerator vessel 10 by contact with hot regenerated catalyst.

The spent catalyst pipe inlet 12i discharges a stream of spent catalyst from a spent catalyst standpipe 12 into the mixing chamber 50, and the regenerated catalyst pipe inlet 16i discharges the recycled portion of regenerated catalyst from the regenerated catalyst standpipe 16 into the mixing chamber 50. The mixing chamber 50 receives a stream of spent catalyst and a stream of regenerated catalyst and mixes them together to provide a mixture of catalyst. While mixing, the hotter regenerated catalyst heats the cooler spent catalyst which serves to provide a heated catalyst mixture.

A mixing baffle 60 may be positioned within the mixing chamber 50 in an embodiment, to facilitate mixing between the spent catalyst and the regenerated catalyst. The mixing baffle 60 may comprise a capped cylinder with openings 68 opposed to catalyst inlets 12i or 16i.

An oxygen supply gas distributor 52 emits oxygen supply gas into the mixing chamber 50. The oxygen supply gas distributed from the oxygen supply gas distributor 52 includes oxygen necessary for combustion. The oxygen supply gas may also fluidize the catalyst within the mixing chamber 50 and lift the catalyst from the mixing chamber upwardly into the combustion chamber 20.

Coke on the spent catalyst may be insufficient to generate enough enthalpy from combustion to drive the endothermic reaction in the dehydrogenation reactor. In some cases, the catalyst may deactivate by a mechanism other than coke deposition and require oxidation to regenerate activity, even though very little or no detectable coke is on the spent catalyst. Moreover, higher regeneration temperature results in greater restoration of catalyst activity. Hence, supplemental fuel gas is added to the mixing chamber 50 in the regenerator vessel 10 to provide additional combustion enthalpy to drive the endothermic reaction in the dehydrogenation reactor and sufficiently restore catalyst activity. The regenerator vessel 10 may include a fuel gas distributor 28 for distributing fuel gas from fuel gas supply line 27 to the mixing chamber 50 for combustion in the combustion chamber 20. The fuel gas is combusted with oxygen in the oxygen supply gas in the presence of the catalyst to provide a heated, regenerated catalyst. Moreover, coke on catalyst is also combusted from the catalyst with oxygen in the oxygen supply gas to provide a regenerated catalyst. Combustion of coke and fuel gas generates flue gas. In an embodiment, the fuel gas and the coke on the catalyst are combusted together in the same vicinity, beginning in the mixing chamber 50 and then in the combustion chamber 20.

The superficial gas velocity in the mixing chamber 50 may about 0.9 m/s (3 ft/s), to about 5.4 m/s (18 ft/s), and the catalyst density may be from about 112 kg/m³ (7 lb/ft³) to about 400 kg/m³ (25 lb/ft³), preferably from about 48 kg/m³ (3 lb/ft′) to about 288 kg/m³ (18 lb/ft³), constituting a dense catalyst phase in the mixing chamber 50.

In an exemplary embodiment, a gas that has a higher concentration of oxygen than air is used as the oxygen supply gas. The concentration of oxygen in the oxygen supply gas should be greater than 21 vol %, suitably, between about 21 and about 40 vol % and preferably between about 22 and about 30 vol %. Air with 21 vol % oxygen is more concentrated than typical air streams because water typically is present in air at about 3 to about 6 vol %. Air enriched with oxygen may be used as the oxygen supply gas. The oxygen supply gas also may contain water, carbon dioxide, nitrogen, argon, and other atmospheric gases. In some embodiments the oxygen supply gas may contain between 2 and 6 vol % water.

Exemplary regeneration conditions in the combustion chamber 20 include a temperature from about 690° C. to about 800° C., preferably 705° C. to about 750° C. and a pressure of about 6.9 kPa (gauge) (1 psig) to about 450 kPa (gauge) (70 psig) in the combustion chamber 20.

Coke is deposited on the catalyst in the paraffin dehydrogenation reaction. The catalyst can comprise from 250 to about 1250 ppm carbon by weight and typically about 400 to about 1000 ppm carbon by weight. The coke is burned off the spent catalyst by contact with oxygen in the oxygen supply gas at regeneration conditions.

The oxygen concentration in the flue gas stream exiting the combustion chamber 20 should be greater than 4 vol %, preferably at least 5 vol %. The oxygen concentration in the flue gas stream exiting the combustion chamber 20 may be no more than 15 vol % and suitably no more than 12 vol %. The flue gas also comprises water and carbon dioxide generated by combustion of fuel gas and which enters with the oxygen supply gas stream. This results in significant amounts of water in the flue gas stream exiting the combustion chamber 20. For example, water concentration in the flue gas stream exiting the combustion chamber 20 may be typically greater than about 15 vol % and typically no more than about 25 vol %. The carbon dioxide concentration in the flue gas stream exiting the combustion chamber 20 typically may be between about 5 vol % and about 10 vol %. The flue gas stream exiting the regenerator vessel 10 in line 44 may have about the same oxygen concentration as that exiting the combustion chamber 20.

The fuel gas fed to the regenerator vessel 10 in line 27 may comprise about 6 to about 13 vol % of all the gases fed to the combustion chamber 20. The balance is the oxygen supply gas fed to the regenerator vessel 10 in line 49. Of all the gases fed to the combustion chamber 20 of the regenerator vessel 10, including oxygen supply gas and fuel gas, oxygen should comprise about should be about 20 to about 28 vol % of the gas.

Uncombusted fuel gas, flue gas, oxygen supply gas with a lower concentration of oxygen and catalyst ascend from the mixing chamber 50 through the combustion chamber 20. Catalyst, fuel gas and oxygen supply gas ascend in the combustion chamber 20 while coke is combusted from the catalyst and the fuel gas is combusted to regenerate and heat the catalyst and generate flue gas. The flow regime may be a fast-fluidized flow regime in which catalyst may slip relative to the gas and the gas can take indirect upward trajectories. The superficial velocity of the gases ascending in the combustion chamber 20 is preferably about 1.5 m/s (5 ft/s) to about 6 m/s (20 ft/s) and preferably about 2.1 m/s (7 ft/s) to about 5.4 m/s (18 ft/s), to provide a fast-fluidized flow regime. The catalyst density in the dilute catalyst phase in the combustion chamber 20 will be from about 16 kg/m³ (1 lb/ft³) to about 192 kg/m³ (12 lb/ft³).

The blend of gases and catalyst ascend from the combustion chamber 20 through a frustoconical transition section 41 into a riser 46 which has a smaller diameter than a major diameter of the combustion chamber 20. A blend of gases and catalyst accelerate in the narrower riser 46 and are discharged from a riser termination device 48 into the separation chamber 22. The transition section 41, the riser 46 and the riser termination device 48 are considered part of the combustion chamber 20. The riser termination device 48 may utilize centripetal acceleration to separate regenerated catalyst from flue gas. The superficial gas velocity in the riser 46 will be about 6 m/s (20 ft/s) to about 15 m/s (50 ft/s) and constitute a dilute catalyst phase.

Regenerated catalyst separated from flue gas by the riser termination device 48 drops into a dense catalyst bed 32. The catalyst separation chamber 22 may include one or more regenerator cyclones 38 or other solid/gaseous separator devices to separate the regenerated catalyst still entrained in the flue gas. In an aspect, primary cyclones 38 may collect flue gas from the separation chamber 22 and transport the flue gas separated from catalyst to a secondary cyclone 39 to further separate regenerated catalyst from the flue gas before directing secondarily purified flue gas to the plenum 42. Flue gas is discharged from the regenerator vessel 10 through an outlet 43 in a discharge line 44. Regenerated catalyst separated from flue gas in the cyclones 38, 39 is dispensed by dip legs into the dense catalyst bed 32.

A stream of fluidizing gas from bed gas line 54 may be distributed into the separation chamber 22 by a bed distributor 56 to fluidize regenerated catalyst in the dense catalyst bed 32. The fluidizing gas may be an oxygen supply gas such as air, or oxygen enriched air like used in the combustion chamber 20 or it may be inert such as steam or nitrogen.

A return portion of the regenerated catalyst collected in the dense bed 32 of the catalyst separation chamber 22 may be transported in the return regenerated catalyst standpipe 14 back to the dehydrogenation reactor ready for catalyzing dehydrogenation reactions. The return portion of the regenerated catalyst may exit the separation chamber 22 through an outlet 72 to enter the return regenerated catalyst standpipe 14. A stripper section 74 equipped with packing or stripping internals 76 may be provided to facilitate stripping of the regenerated catalyst with stripping gas from line 78 to flue gas or other gas entrained or adsorbed on the regenerated catalyst before it is returned to the dehydrogenation reactor through the return regenerated catalyst standpipe 14 at a rate governed by a control valve thereon. The stripping gas may be an oxygen supply gas such as air, or oxygen enriched air like used in the combustion chamber 20 or it may be inert such as steam or nitrogen.

A recycle portion of the regenerated catalyst collected in the dense bed 32 of the catalyst separation chamber 22 may be recycled in a recycle regenerated catalyst standpipe 16 back to the combustion chamber 20 of the regenerator vessel 10 via the mixing chamber 50. The regenerated catalyst is hotter and has a lower coke concentration than the spent catalyst fed to the regenerator vessel in standpipe 12.

The rate of recycle of regenerated catalyst can be controlled by operation of the control valve on the recycle regenerated catalyst standpipe 16 independently of the rate of spent catalyst to the regenerator vessel 10 by operation of the control valve on the spent catalyst pipe 12 to adjust the density of the catalyst. The density of the catalyst is directly proportional to the residence time of catalyst in the regenerator vessel 10 and particularly the residence time of the catalyst in the mixing chamber 50. Consequently, by adjusting the density of the catalyst in the mixing chamber 50 through varying the recycle rate of regenerated catalyst through the control valve on the recycle regenerated catalyst standpipe 16, the residence time of catalyst in the regenerator vessel 10 can be adjusted to ensure sufficient combustion and enthalpy absorbed by the catalyst and transferred to the dehydrogenation reactor.

The recycle rate of the regenerated catalyst through the recycle regenerated catalyst standpipe 16 to the mixing chamber 50 may be about 0.5 to about 5 times that of the rate of spent catalyst through the spent catalyst standpipe 12 to the mixing chamber. Suitably the recycle rate may be about 0.7 to about 3 times the rate of spent catalyst through the spent catalyst standpipe 12 to the mixing chamber 50.

The oxygen supply gas may be in contact with the spent catalyst for an average residence time of under about 2 minutes and preferably no more than about 90 seconds before initial separation in the riser termination device 48. Residence time of spent catalyst before initial separation or in the combustion chamber 20 begins with the spent catalyst entering the regenerator vessel 10 from the spent catalyst standpipe 12 and ends upon discharge from the riser termination device 48. Average residence time is calculated by the ratio of the volume of the regenerator vessel in question to the catalyst circulation rate. The volume of the regenerator vessel 10 upstream of separation includes the combustion chamber 20 which includes the mixing chamber 50, the transition section 41 and the riser 46. Due to catalyst recycle in the recycle standpipe 16, the average residence time for the spent catalyst per pass is the average residence time multiplied by the recycle ratio of the flow rate of recycle catalyst to the flow rate of spent catalyst fed to the combustion chamber 20. For example, if the recycle ratio is 1:1, the average residence time for the spent catalyst per pass is the average residence time multiplied by one-half. The average residence time per pass before initial separation should be no more than 1 minute and preferably no more than 45 seconds.

The oxygen supply gas may be in contact with the regenerated catalyst for an average residence time of under 1.5 minutes and preferably no more than 70 seconds after entering the separation chamber 22 after exiting the combustion chamber 20 and before exiting the regenerator vessel 10 through the return regenerated catalyst standpipe 14. Residence time of regenerated catalyst after entering the separation chamber 22 and before exiting the regenerator vessel 10 through the return regenerated catalyst standpipe 14 begins with the regenerated catalyst entering the separation chamber 22 from the riser termination device 48 and ends upon discharge from the regenerated catalyst stripper section 74. The volume of the regenerator vessel 10 downstream of separation includes the separation chamber 22 and the stripper section 74. Due to catalyst recycle in the recycle standpipe 16, the average residence time for the regenerated catalyst per pass is the average residence time in the separation chamber 22 multiplied by the recycle ratio of the flow rate of recycle catalyst to the flow rate of spent catalyst fed to the combustion chamber 20. However, the adjustment is not made for the stripper section 74. For example, if the recycle ratio is 1:1, the average residence time for the regenerated catalyst per pass is the average residence time in the separation chamber 22 multiplied by one-half plus the average residence time in the stripper section 74. The average residence time per pass before initial separation should be no more than 1 minute and preferably no more than 50 seconds.

The average residence time of catalyst in the regenerator vessel should be no more than three minutes and preferably no more than about 2.5 minutes. The average residence time per pass should be no more than 100 seconds and preferably no more than about 90 seconds.

The foregoing disclosure provides a process for regenerating gallium catalyst by contact with enriched oxygen gas while obviating or eliminating a subsequent oxygen treatment.

### EXAMPLES

### Example 1

Catalyst was prepared by incipient wetness impregnation of an aqueous solution of gallium nitrate, potassium nitrate, and tetraamine platinum nitrate on a micro-spheroidal spray dried alumina containing 1% SiO2. The catalyst support had BET surface area of 134 m²/g measured by nitrogen adsorption. Impregnation was followed by calcination in air for 4 hours at 750 C. Catalyst contained 0.0076% Pt, 1.56% Ga, 0.26% K, 0.5% Si (by weight) as measured by inductively charged plasma atomic emission spectroscopy (ICP-AES). Catalyst appearance was white. Carbon and nitrogen content were measured by CHN method D5291. Carbon content of the fresh catalyst was 0.07 wt %, close to the detection limit of 0.05 wt % (likely due to adsorbed carbonates). Nitrogen was not detectable (detection limit 0.05 wt %). Bulk density of the catalyst was 0.83 cm³/g.

Long-term aging of catalyst was simulated by cycling the catalyst between reactor and regenerator conditions as follows:

Startup: Two cm³ of catalyst was loaded in a quartz tube reactor. Catalyst was heated to 120° C. in nitrogen and held 30 minutes. Temperature was increased to 720° C. in nitrogen at 10° C./min and regeneration conditions were initiated.
Regeneration step: Temperature was increased to 720° C. in nitrogen at 10° C./min. Gas composition was changed from nitrogen to 2.4% 02, 3.8% CO₂, 24.2% H₂O (by volume) and was flowed for 2 minutes with gas flow rate of 15 standard cm³ per minute per cm³ of catalyst. Gas composition was changed back to nitrogen, temperature was held for 0.5 min, and cooling was initiated.
Reaction step: Sample was cooled to 620° C. in nitrogen at 13° C./min. Gas composition was changed from nitrogen to propane. Propane was flowed for 2 minutes with gas flow rate of 7.5 cm³ per minute per cm³ of catalyst. Gas composition was changed back to nitrogen, temperature was held for 0.5 min, and heating for regeneration step was initiated.
630 cycles of regeneration-reaction were completed with an additional regeneration at the end of the program. Catalyst was cooled in nitrogen and unloaded for further testing.

### Example 2

150 mg of cycle-aged catalyst from Example 1 was loaded between quartz wool plugs in a quartz tube reactor with inner diameter 3.85 mm. Inert alpha alumina spheres were loaded below the catalyst bed to minimize thermal cracking. The reactor effluent composition was analyzed by transmission infrared spectroscopy which identified propane, propene, ethane, ethene, and methane products with data collection approximately every 7 sec. The effluent of the infrared analyzer was directed to a gas chromatograph which was used to occasionally analyze the product stream and check the accuracy of the infrared analyzer on the real product stream.

Catalyst was dried in nitrogen and held for 30 minutes at 120° C., then heated to 720° C. in nitrogen. The catalyst was then exposed to a mixture of dry gas consisting of 2.5% O₂, with the balance nitrogen where the dry gas flow (O₂+nitrogen) was 15 standard cm³/min, mixed with 25 mol % steam generated by vaporizing water which was fed from a pump. Exposure to this steam/O₂/nitrogen mixture was sustained for 1 minute, at which point it was discontinued and replaced with dry nitrogen.

After this pretreatment, the catalyst was cooled to 620° C. in dry nitrogen. The catalyst was then exposed to 2 mol % H₂O in nitrogen, generated by bubbling nitrogen through a saturator in a temperature-controlled bath. The wet pre-treatment of the catalyst was maintained for 60 minutes. The nitrogen/H₂O mixture was then stopped and replaced with 9 standard cm³/min of propane and 1.5 standard cm³/min of hydrogen feed. Feed was flowed for 2 minutes, after which gas composition was switched to nitrogen, and temperature was increased to 720° C. for regeneration. During regeneration, the catalyst was then exposed to a mixture of dry gas consisting of 2.5% O₂, balance nitrogen where the dry gas flow (O₂+nitrogen) was 15 standard cm³/min, mixed with 25 mol % steam generated by vaporizing water which was fed from a pump. Exposure to this steam/O₂/nitrogen mixture was sustained for 1 minute, at which point it was discontinued and replaced with dry nitrogen. The catalyst was then heated to the next regeneration step. The O₂/propane cycles were repeated four times, ending with a reaction cycle. The propane conversion at or near 0.65 min on stream is shown in Table 1.

### Example 3

Same as Example 2 except pretreatment and regeneration dry gas composition was 5% O₂, with the balance nitrogen instead of 2.5% O₂, with the balance nitrogen. The propane conversion at or near 0.65 min on stream is shown in Table 1.

### Example 4

Same as Example 2 except pretreatment and regeneration dry gas composition was 7.5% O₂, with the balance nitrogen instead of 2.5% O₂, with the balance nitrogen. The propane conversion at or near 0.65 min on stream is shown in Table 1.

### Example 5

Same as Example 2 except pretreatment and regeneration dry gas composition was 20% O₂, with the balance nitrogen instead of 2.5% O₂, with the balance nitrogen. The propane conversion at or near 0.65 min on stream is shown in Table 1.

TABLE 1

| | | O₂ in dry gas | | Data from | |
|---|---|---|---|---|---|
| | | used in | Regeneration | time on | Propane |
| | | regeneration^{b} | temperature | stream | conversion |
| Example | Cycle | (mol %) | (° C.) | (min) | (mol %) |
| 2 | 1 | 2.5% | 720 | 0.65 | 39.67 |
| 2 | 2 | 2.5% | 720 | 0.65 | 39.44 |
| 2 | 3 | 2.5% | 720 | 0.54, 0.76^{a} | 41.59, |
| | | | | | 40.47 |
| 2 | 4 | 2.5% | 720 | 0.65 | 41.39 |
| 3 | 1 | 5% | 720 | 0.65 | 43.06 |
| 3 | 2 | 5% | 720 | 0.65 | 43.86 |
| 3 | 3 | 5% | 720 | 0.65 | 44.73 |
| 3 | 4 | 5% | 720 | 0.65 | 46.14 |
| 4 | 1 | 7.5% | 720 | 0.54, 0.76^{a} | 45.83, |
| | | | | | 44.17 |
| 4 | 2 | 7.5% | 720 | 0.65 | 46.16 |
| 4 | 3 | 7.5% | 720 | 0.65 | 47.19 |
| 4 | 4 | 7.5% | 720 | 0.54, 0.76^{a} | 48.16 |
| 5 | 1 | 20% | 720 | 0.65 | 47.99 |
| 5 | 2 | 20% | 720 | 0.65 | 50 |
| 5 | 3 | 20% | 720 | 0.65 | 49.96 |
| 5 | 4 | 20% | 720 | 0.65 | 50.4 |

^{a}No datapoint at 0.65 min. Data is reported for 0.54 min and 0.76 min.
^{b}Stream also contained 25 mol % steam.

### Example 6

Same as Example 5 except 200 mg of catalyst was loaded in the reactor instead of 150 mg, the pretreatment and regeneration temperature was 700° C. instead of 720° C., the pretreatment and regeneration flow rate was 17 standard cm³/min instead of 15 cm³/min, the regeneration and pretreatment gas composition was 20 mol % O₂, balance nitrogen, with 7.3 mol % steam instead of 25 mol %. Also, the amount of H₂O in the H₂O/nitrogen stream at 620° C. prior to propane exposure was 0.3 mol % instead of 2 mol %. After the last reaction cycle the catalyst was slightly grey and the amount of carbon on catalyst was measured using CHN method D5291. The spent catalyst contained only 0.07 wt % carbon. Conversion of propane is shown in Table 2.

### Example 7

Same as Example 6 except the regeneration and pretreatment flow rate was 7 standard cm³/min instead of 17 cm³/min and the regeneration and pretreatment dry gas composition was 3 mol % 02, 5% mol % CO₂, balance nitrogen and 25 mol % steam was added instead of 7.3 mol % steam. After the last reaction cycle the catalyst was slightly grey and the amount of carbon on catalyst was measured using CHN method D5291. The spent catalyst carbon content was lower than the detection limit of 0.05 wt %. Conversion of propane is shown in Table 2.

TABLE 2

| | | O₂ in dry gas | | | Data from | |
|---|---|---|---|---|---|---|
| | | used in | Steam used in | Regeneration | time on | Propane |
| | | regeneration | regeneration | temperature | stream | conversion |
| Example | Cycle | (mol %) | (mol %) | (° C.) | (min) | (mol %) |
| 6 | 1 | 20% | 7.3% | 720 | 0.76 | 49.90 |
| 6 | 2 | 20% | 7.3% | 720 | 0.76 | 50.97 |
| 6 | 3 | 20% | 7.3% | 720 | 0.65 | 51.02 |
| 6 | 4 | 20% | 7.3% | 720 | 0.65 | 50.61 |
| 7 | 1 | 3% | 25% | 720 | 0.76 | 41.54 |
| 7 | 2 | 3% | 25% | 720 | 0.76 | 42.48 |
| 7 | 3 | 3% | 25% | 720 | 0.76 | 42.45 |
| 7 | 4 | 3% | 25% | 720 | 0.76 | 44.33 |

### Example 8

Same as Example 3 except the pretreatment and regeneration temperature was 690° C. instead of 720° C. Results are shown in Table 3.

### Example 9

Same as Example 3 except the pretreatment and regeneration temperature was 705° C. instead of 720° C. Results are shown in Table 3.

### Example 10

Same as Example 3 except the pretreatment and regeneration temperature was 735° C. instead of 720° C. Results are shown in Table 3.

TABLE 3

| | | O₂ in dry gas | | Data from | |
|---|---|---|---|---|---|
| | | used in | Regeneration | time on | Propane |
| | | regeneration^{b} | temperature | stream | conversion |
| Example | Cycle | (mol %) | (° C.) | (min) | (mol %) |
| 8 | 1 | 5% | 690 | 0.76 | 35.90 |
| 8 | 2 | 5% | 690 | 0.65 | 38.84 |
| 8 | 3 | 5% | 690 | 0.65 | 40.18 |
| 8 | 4 | 5% | 690 | 0.76 | 40.68 |
| 9 | 1 | 5% | 705 | 0.65 | 41.09 |
| 9 | 2 | 5% | 705 | 0.65 | 42.61 |
| 9 | 3 | 5% | 705 | 0.76 | 43.11 |
| 9 | 4 | 5% | 705 | 0.76 | 43.75 |
| 3 | 1 | 5% | 720 | 0.65 | 43.06 |
| 3 | 2 | 5% | 720 | 0.65 | 43.86 |
| 3 | 3 | 5% | 720 | 0.65 | 44.73 |
| 3 | 4 | 5% | 720 | 0.65 | 46.14 |
| 10 | 1 | 5% | 735 | 0.65 | 44.22 |
| 10 | 2 | 5% | 735 | 0.65 | 45.74 |
| 10 | 3 | 5% | 735 | 0.65 | 46.54 |
| 10 | 4 | 5% | 735 | 0.65 | 47.19 |

^{b}Stream also contained 25 mol % steam.

### SPECIFIC EMBODIMENTS

While the following is described in conjunction with specific embodiments, it will be understood that this description is intended to illustrate and not limit the scope of the preceding description and the appended claims.

A first embodiment of the disclosure is a process for regenerating a catalyst comprising gallium comprising combusting fuel gas with oxygen in the presence of the catalyst to provide a regenerated catalyst, wherein the oxygen is provided in an oxygen supply gas that has an oxygen concentration of greater than 21 vol %. An embodiment of the disclosure is one, any or all of prior embodiments in this paragraph up through the first embodiment in this paragraph further comprising combusting coke from the catalyst and the fuel gas together. An embodiment of the disclosure is one, any or all of prior embodiments in this paragraph up through the first embodiment in this paragraph wherein the oxygen supply gas has an oxygen concentration of about 21 to about 40 vol %. An embodiment of the disclosure is one, any or all of prior embodiments in this paragraph up through the first embodiment in this paragraph wherein the catalyst comprises less than 1000 ppm carbon by weight before the combustion step. An embodiment of the disclosure is one, any or all of prior embodiments in this paragraph up through the first embodiment in this paragraph wherein the combustion step occurs at a temperature between about 670 and about 750° C. An embodiment of the disclosure is one, any or all of prior embodiments in this paragraph up through the first embodiment in this paragraph wherein the concentration of oxygen in the flue gas after combustion is about 4 to about 15 vol %. An embodiment of the disclosure is one, any or all of prior embodiments in this paragraph up through the first embodiment in this paragraph further comprising separating the regenerated catalyst from flue gases and passing at least a portion of the hot regenerated catalyst to a dehydrogenation reactor. An embodiment of the disclosure is one, any or all of prior embodiments in this paragraph up through the first embodiment in this paragraph comprising recycling a portion of the regenerated catalyst to the combustion step. An embodiment of the disclosure is one, any or all of prior embodiments in this paragraph up through the first embodiment in this paragraph wherein the spent catalyst is in contact with the oxygen supply gas for an average of under 2 minutes before initial separation.

A second embodiment of the disclosure is a process for regenerating a catalyst comprising noble metal and gallium comprising feeding a stream of coked catalyst to a regenerator vessel; feeding a stream of oxygen supply gas having a concentration of oxygen greater than 21 vol % to the regenerator vessel; feeding a stream of fuel gas to the regenerator vessel; combusting coke from the coked catalyst and combusting the fuel gas with the oxygen supply gas to provide a regenerated catalyst and flue gas; and separating the regenerated catalyst from the flue gas. An embodiment of the disclosure is one, any or all of prior embodiments in this paragraph up through the second embodiment in this paragraph wherein the coke combustion and the fuel gas combustion occur together. An embodiment of the disclosure is one, any or all of prior embodiments in this paragraph up through the second embodiment in this paragraph wherein the oxygen supply gas has a concentration of about 22 to about 40 vol %. An embodiment of the disclosure is one, any or all of prior embodiments in this paragraph up through the second embodiment in this paragraph wherein the combustion occurs in a combustion chamber of the regenerator vessel and further comprising separating the regenerated catalyst from flue gases in a separation chamber of the regenerator vessel and further comprising passing the hot regenerated catalyst from the regenerator vessel to a dehydrogenation reactor. An embodiment of the disclosure is one, any or all of prior embodiments in this paragraph up through the second embodiment in this paragraph wherein the concentration of oxygen in the flue gas after separation from the flue gas is about 4 to about 15 vol %. An embodiment of the disclosure is one, any or all of prior embodiments in this paragraph up through the second embodiment in this paragraph comprising recycling a portion of the regenerated catalyst from the separation chamber to the combustion chamber. An embodiment of the disclosure is one, any or all of prior embodiments in this paragraph up through the second embodiment in this paragraph further comprising distributing a stream of oxygen supply gas to the separation chamber. An embodiment of the disclosure is one, any or all of prior embodiments in this paragraph up through the second embodiment in this paragraph wherein the catalyst is in regenerator vessel for an average residence time of less than 2 minutes before it enters the separation chamber. An embodiment of the disclosure is one, any or all of prior embodiments in this paragraph up through the second embodiment in this paragraph further comprising stripping the catalyst with an oxygen supply gas after the regenerated catalyst is separated from the flue gas. An embodiment of the disclosure is one, any or all of prior embodiments in this paragraph up through the second embodiment in this paragraph further comprising discharging flue gas from the regenerator vessel comprising about 4 to about 15 vol % oxygen.

A third embodiment of the disclosure is a process for regenerating a catalyst comprising noble metal and gallium comprising feeding a stream of coked catalyst to a chamber in a regenerator vessel; feeding a stream of oxygen supply gas the chamber in the regenerator vessel; feeding a stream of fuel gas to the chamber in the regenerator vessel; and combusting coke from the coked catalyst and combusting the fuel gas with the oxygen supply gas in the chamber in the regenerator vessel to provide a regenerated catalyst and flue gas, where in the concentration of oxygen in all the gas streams fed to the chamber in the regenerator vessel is between about 20 and about 28 vol %.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for regenerating a catalyst comprising gallium comprising:
combusting fuel gas with oxygen in the presence of the catalyst to provide a regenerated catalyst, wherein the oxygen is provided in an oxygen supply gas that has an oxygen concentration of greater than 21 vol %.

2. The process of claim 1 further comprising combusting coke from the catalyst and the fuel gas together.

3. The process of claim 1 wherein the oxygen supply gas has an oxygen concentration of about 21 to about 40 vol %.

4. The process of claim 1 wherein said catalyst comprises less than 1000 ppm carbon by weight before the combustion step.

5. The process of claim 1 wherein the combustion step occurs at a temperature between about 670 and about 750° C.

6. The process of claim 1 wherein the concentration of oxygen in the flue gas after combustion is about 4 to about 15 vol %.

7. The process of claim 1 further comprising separating the regenerated catalyst from flue gases and passing at least a portion of said hot regenerated catalyst to a dehydrogenation reactor.

8. The process of claim 7 comprising recycling a portion of said regenerated catalyst to the combustion step.

9. The process of claim 7 wherein the spent catalyst is in contact with the oxygen supply gas for an average of under 2 minutes before initial separation.

10. A process for regenerating a catalyst comprising noble metal and gallium comprising:
feeding a stream of coked catalyst to a regenerator vessel;
feeding a stream of oxygen supply gas having a concentration of oxygen greater than 21 vol % to said regenerator vessel;
feeding a stream of fuel gas to said regenerator vessel;
combusting coke from said coked catalyst and combusting said fuel gas with said oxygen supply gas to provide a regenerated catalyst and flue gas; and
separating said regenerated catalyst from said flue gas.

11. The process of claim 10 wherein the coke combustion and the fuel gas combustion occur together.

12. The process of claim 10 wherein the oxygen supply gas has a concentration of about 22 to about 40 vol %.

13. The process of claim 10 wherein the combustion occurs in a combustion chamber of the regenerator vessel and further comprising separating the regenerated catalyst from flue gases in a separation chamber of the regenerator vessel and further comprising passing said hot regenerated catalyst from said regenerator vessel to a dehydrogenation reactor.

14. The process of claim 13 wherein the concentration of oxygen in the flue gas after separation from the flue gas is about 4 to about 15 vol %.

15. The process of claim 13 comprising recycling a portion of said regenerated catalyst from said separation chamber to the combustion chamber.

16. The process of claim 13 further comprising distributing a stream of oxygen supply gas to said separation chamber.

17. The process of claim 13 wherein the catalyst is in regenerator vessel for an average residence time of less than 2 minutes before it enters the separation chamber.

18. The process of claim 13 further comprising stripping said catalyst with an oxygen supply gas after the regenerated catalyst is separated from the flue gas.

19. The process of claim 10 further comprising discharging flue gas from said regenerator vessel comprising about 4 to about 15 vol % oxygen.

20. A process for regenerating a catalyst comprising noble metal and gallium comprising:
feeding a stream of coked catalyst to a chamber in a regenerator vessel;
feeding a stream of oxygen supply gas said chamber in said regenerator vessel;
feeding a stream of fuel gas to said chamber in said regenerator vessel; and
combusting coke from said coked catalyst and combusting said fuel gas with said oxygen supply gas in said chamber in the regenerator vessel to provide a regenerated catalyst and flue gas, wherein the concentration of oxygen in all the gas streams fed to the chamber in the regenerator vessel is between about 20 and about 28 vol %.
